(19) United States
(12) Patent Application Publication
(10) Pub. No.: US 2005/0241449 A1
(43) Pub. Date: Nov. 3, 2005

(54) Cutting machine for cutting paper into chips

(76) Inventor: Ching Mei Chen, Taichung (TW)

Correspondence Address: Ching Mei CHEN, P.O.Box 63-298, Taichung, 406, TW

(21) Appl. No.: 10/837,285

(22) Filed: May 1, 2004

(51) Int. Cl. B26D 1/147

(52) U.S. Cl. 83/349; 83/906

(57) ABSTRACT

A cutting machine includes a housing and a fixed cutter blade supported on a table, a reel of paper sheet disposed on the housing, a drum rotatably supported on the table and having one or more cutter blades disposed adjacent to and movable relative to the fixed cutter blade. A feeding device may feed the paper sheet toward the cutter blades for being cut by the cutter blades into cut chips. A platform is slidably attached to the table to support the housing and the fixed cutter blade, to adjust the cutter blades relative to each other. The housing is adjustable relative to the platform to selected angular position.

### BACKGROUND OF THE INVENTION

1. Field of the Invention

The present invention relates to a cutting machine, and more particularly to a cutting machine for easily and quickly cutting paper sheets or gold foils or the like into smaller cut chips, and for automatically collecting the cut chips.

2. Description of the Prior Art

Typical cutting machines comprise a base having a fixed cutter edge or blade formed or provided therein, and a movable cutter blade pivotally attached or coupled to the base, and rotatable relative to the base, and movable toward and away from the fixed cutter edge or blade for cutting or trimming paper sheets.

Normally, the typical cutting machines may be used to cut or trim paper sheets into longitudinal paper straps or strips only, but may not easily cut or trim paper sheets into square, or rectangular, or triangular or hexagonal paper cut chips.

For allowing the paper sheets to be cut or trimmed into square, or rectangular, or triangular or hexagonal paper cut chips, the longitudinal paper straps or strips should further be cut or trimmed by the typical cutting machines again, to cut the longitudinal paper straps or strips in a direction perpendicular to the longitudinal paper, in order to form the smaller square, or rectangular, or triangular or hexagonal paper cut chips.

However, it is time consuming and it takes a lot of labor work and it will be difficult to cut paper sheets into the smaller square, or rectangular, or triangular or hexagonal paper cut chips.

The present invention has arisen to mitigate and/or obviate the afore-described disadvantages of the conventional cutting machines.

### SUMMARY OF THE INVENTION

The primary objective of the present invention is to provide a cutting machine for automatically or easily and quickly cutting paper sheets or gold foils or the like into smaller cut chips.

The other objective of the present invention is to provide a cutting machine for automatically collecting the cut chips.

In accordance with one aspect of the invention, there is provided a cutting machine comprising a table, a housing supported on the table, a reel of paper sheet disposed on the housing, a fixed cutter blade disposed on the table, and including a cutter edge, a drum rotatably supported on the table, at least one cutter blade attached to the drum and rotated in concert with the drum, and including a cutter edge disposed adjacent to and movable relative to the cutter edge of the fixed cutter blade, and a feeding device for feeding the paper sheet toward the fixed cutter blade and the cutter blade, for being cut by the cutter edge of the fixed cutter blade and the cutter blade into cut chips.

A platform may further be provided and slidably attached to the table and movable relative to the table, the fixed cutter blade is disposed on the platform and movable relative to the cutter blade.

An adjusting device may further be provided for adjusting the fixed cutter blade relative to the cutter blade, and includes a bolt rotatably supported on the table and threaded to the platform and having a bevel gear provided thereon, a rod rotatably supported on the table and having a bevel gear attached thereto and engaged with the bevel gear of the bolt, to rotate the bolt to adjust the platform relative to the table, and to adjust a relative position between the cutter edges of the fixed cutter blade and the cutter blade.

A housing may further be provided and disposed on the platform, to support the reel of paper sheet. The platform includes a curved groove formed therein, and a fastener is engaged through the housing and slidably engaged in the curved groove of the platform, to rotate and adjust the housing relative to the platform to selected angular positions.

The drum includes at least one slot formed therein to receive the cutter blade. The drum includes at least one slot formed therein to receive the cutter blade, and a bar engaged into the slot of the drum and secured to the drum and engaged with the cutter blade, to secure the cutter blade to the drum.

The drum includes at least one second cutter blade attached to the drum and rotated in concert with the drum, and having a cutter edge disposed adjacent to and movable relative to the cutter edge of the fixed cutter blade.

A spindle may further be provided and rotatably supported on the housing, to support the reel of paper sheet. The paper sheet feeding device includes a roller rotatably attached to the housing, to engage with the paper sheet and to feed the paper sheet toward the fixed cutter blade and the cutter blade.

The housing includes a wheel rotatably received therein and located adjacent to the roller, to retain the paper sheet between the roller and the wheel. The housing includes a casing pivotally secured therein to support the wheel.

The housing includes a threaded member rotatably attached thereto, and threaded with the casing, to adjust the casing and the wheel toward and away from the roller.

The wheel may be pivotally attached to the housing with at least one beam, and the wheel is located adjacent to the roller, to retain the paper sheet between the roller and the wheel. A spring biasing device may further be provided for biasing the beam and the wheel toward the roller.

A lever may further be provided and pivotally attached to the housing with a fastener and may include an actuator provided thereon for engaging with the beam, and for moving and adjusting the wheel relative to the roller.

A shaft may further be provided and rotatably attached to the housing, at least one arm is attached to the shaft and has a wheel attached thereto for engaging with the paper sheet, and a belt coupling the wheel to the roller. The arm includes an extension attached thereto, and extendible or retractable relative to the arm, and the wheel is attached to the extension of the arm.

Further objectives and advantages of the present invention will become apparent from a careful reading of the detailed description provided hereinbelow, with appropriate reference to the accompanying drawings.

### BRIEF DESCRIPTION OF THE DRAWINGS

FIG. 1 is a perspective view of a cutting machine in accordance with the present invention;

FIG. 2 is a partial exploded view of the cutting machine;

FIG. 3 is a front plan view of the cutting machine;

FIG. 4 is a top plan view of the cutting machine;

FIG. 5 is a partial exploded view showing a fixed cutter device of the cutting machine;

FIG. 6 is an enlarged partial perspective view showing a cutting edge of the fixed cutter device of the cutting machine;

FIG. 7 is a partial exploded view showing a movable cutter device of the cutting machine;

FIG. 8 is an enlarged partial plan view showing the relative movement or the relative position between the cutting edges of the fixed cutter device and the movable cutter device of the cutting machine;

FIG. 9 is a top plan view similar to FIG. 4, illustrating the angular adjustment of the cutting machine;

FIG. 10 is an enlarged partial perspective view of a paper feeding device of the cutting machine;

FIG. 11 is a partial exploded view of the paper feeding device of the cutting machine;

FIG. 12 is an enlarged partial rear plan view of the cutting machine;

FIG. 13 is an enlarged partial plan view illustrating the adjustment of the paper feeding device of the cutting machine;

FIG. 14 is another enlarged partial plan view illustrating the adjustment of the paper feeding device of the cutting machine;

FIG. 15 is a further enlarged partial plan view illustrating the adjustment of the paper feeding device of the cutting machine;

FIG. 16 is a front plan view similar to FIG. 3, illustrating the operation of the cutting machine; and

FIGS. 17, 18, 19 are perspective views illustrating the cut chips to be cut or formed by the cutting machine.

### DETAILED DESCRIPTION OF THE PREFERRED EMBODIMENT

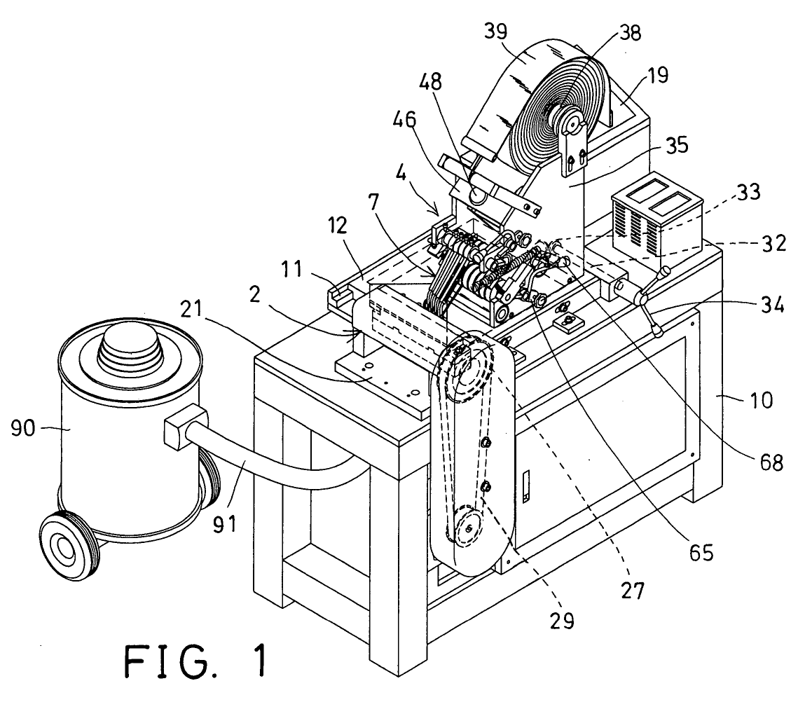

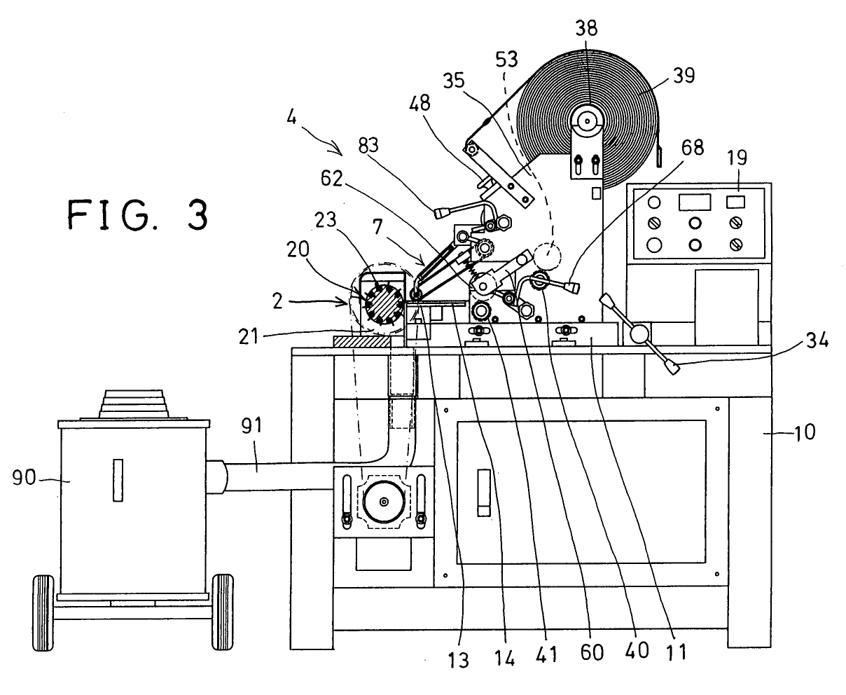

Referring to the drawings, and initially to FIGS. 1-4, a cutting machine in accordance with the present invention comprises a table 10 including one or more, such as two tracks 11 formed or provided thereon, and a platform 12 slidably attached to the tracks 11, and movable relative to the table 10.

A seat 13 is disposed or secured on the platform 12 and movable in concert with the platform 12. A glass or acrylic plate 14 is disposed or secured on the seat 13, and a film 15 is provided or applied or disposed on the plate 14 for static electricity removing purposes.

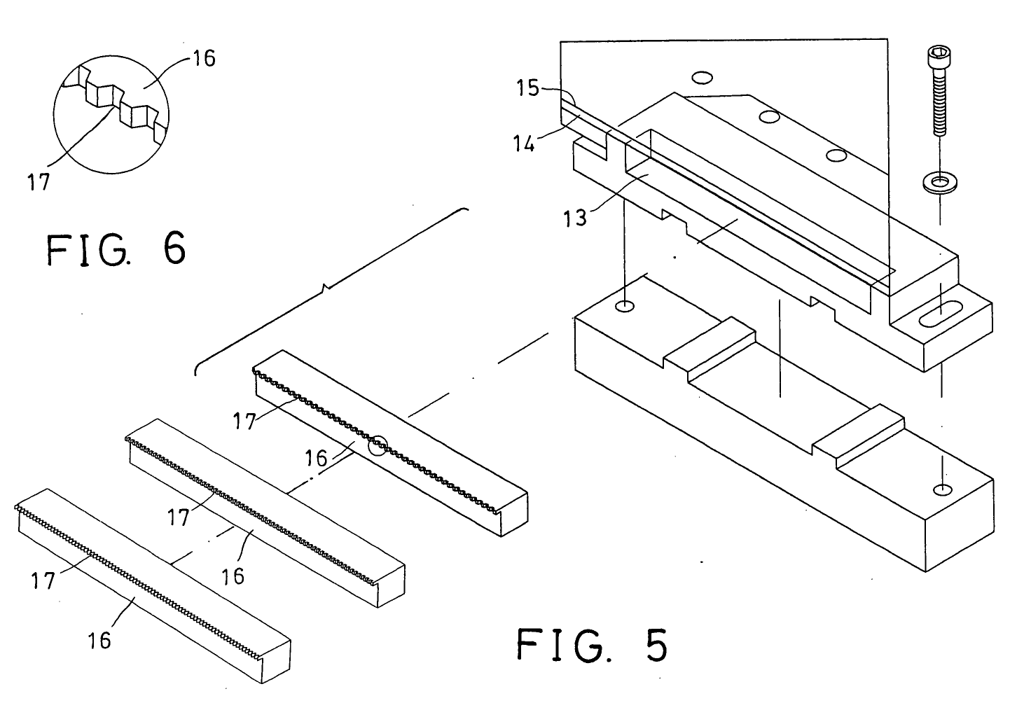

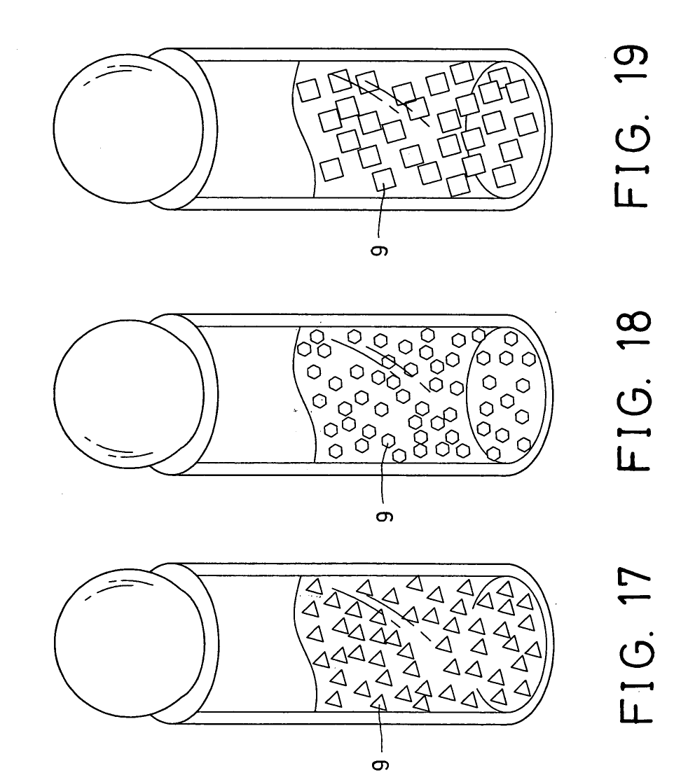

As shown in FIGS. 5 and 6, one or more fixed cutter blades 16 may be selectively or changeably attached or secured to the seat 13, and may include various or different cutter edges 17 provided thereon, to form paper cut chips 9 of various kinds of shapes, as shown in FIGS. 17-19.

As shown in FIGS. 1-4 and 7, a movable cutter device 2 includes a drum 20 rotatably secured or supported on the table 10 with a bracket 21, and having one or more slots 22 formed in the outer peripheral portion thereof, and spaced away from each other, for receiving cutter blades 23 respectively.

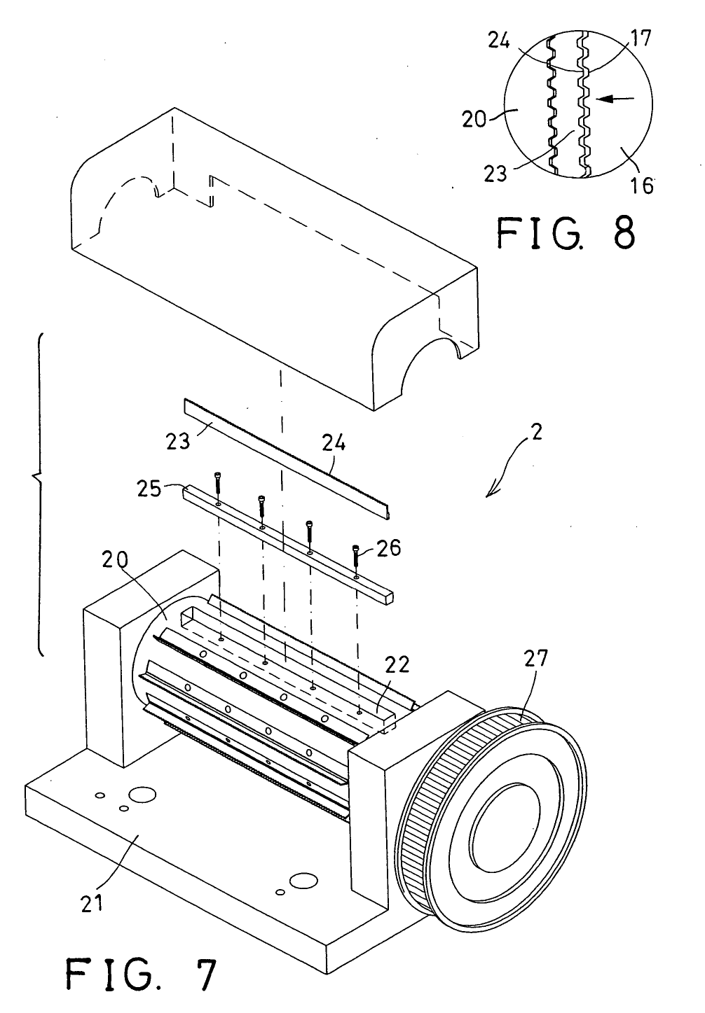

Each of the cutter blades 23 includes a cutter edge 24 corresponding to that of the fixed cutter blades 16, best shown in FIG. 8, for engaging with or for moving toward the fixed cutter blades 16, in order to form the paper cut chips 9, as shown in FIGS. 17-19.

A bar 25 may be engaged into each of the slots 22 of the drum 20, and secured to the drum 20, and engaged with the cutter blades 23, to secure the cutter blades 23 to the drum 20. The cutter blades 23 are rotated in concert with the drum 20, and thus may be taken as movable cutter blades 23.

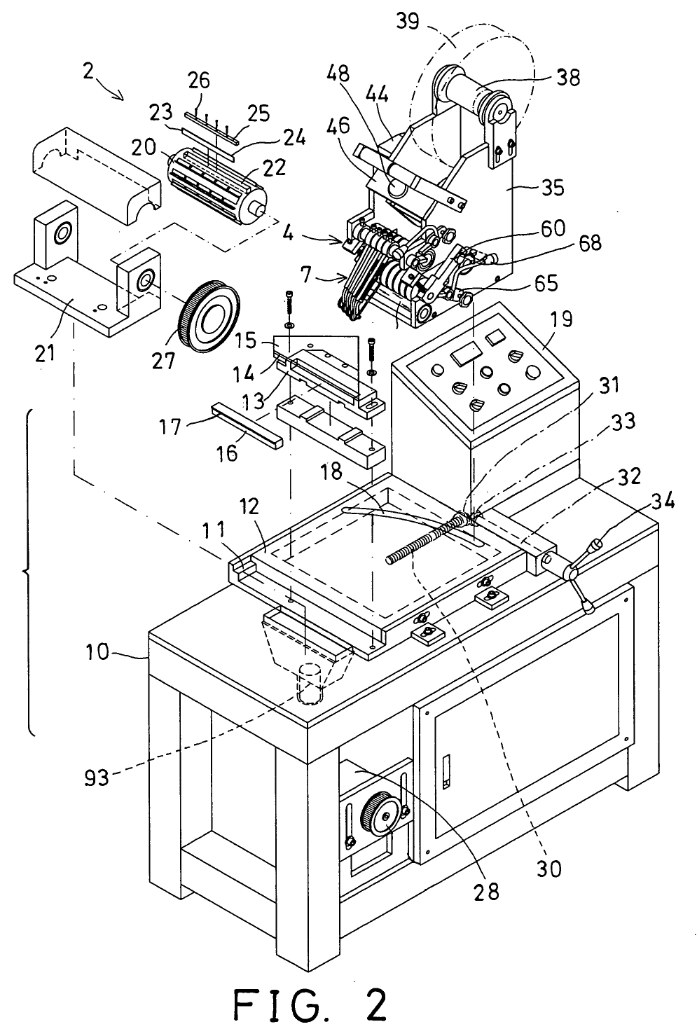

A sprocket or a gear or a pulley 27 may be attached or secured to the drum 20 (FIGS. 1, 2, 7), and may be coupled to a motor 28 (FIG. 2) with a sprocket-and-chain coupling device (not shown), or a gearing device (not shown), or a pulley-and-belt coupling device 29, for allowing the drum 20 and the cutter blades 23 to be rotated or driven by the motor 28.

The cutter edges 24 of the cutter blades 23 are located adjacent to and rotatable or movable over the cutter edges 17 of the fixed cutter blades 16 one by one or alternatively when the drum 20 and the cutter blades 23 are rotated relative to the fixed cutter blades 16 and the platform 12 and the table 10, in order to cut a paper sheet 39 that will be sent or fed toward the cutter blades 15, 23, into the cut chips 9.

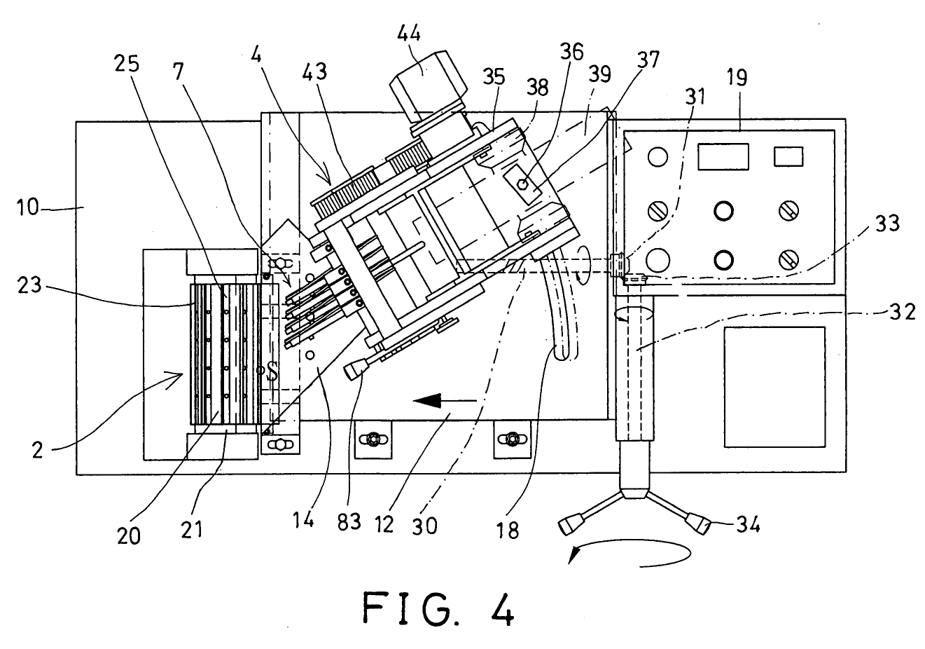

As shown in FIGS. 2 and 4, a bolt 30 is rotatably supported on the table 10, and threaded to the platform 12, and includes a bevel gear 31 extended out of the platform 12. A rod 32 is rotatably supported on the table 10, and also includes a bevel gear 33 attached thereto, and engaged with the bevel gear 31 of the bolt 30, for rotating the bolt 30.

In operation, as shown in FIG. 4, the bolt 30 may be rotated by the rod 32 when the rod 32 is rotated relative to the table 10, in order to move the platform 12 relative to the tracks 11 of the table 10, in order to move or adjust the relative position between the cutter edges 24 of the cutter blades 23 and the cutter edges 17 of the fixed cutter blades 16, best shown in FIG. 8, and so as to form the paper cut chips 9 of different areas or widths or lengths or shapes.

As shown in FIGS. 1-4, a handle 34 may be attached or secured to the rod 32, to facilitate rotating of the rod 32, and to easily move the platform 12 relative to the tracks 11 of the table 10, and thus to easily adjust the cutter edges 24 of the cutter blades 23 relative to the cutter edges 17 of the fixed cutter blades 16. Alternatively, the platform 12 and the plate 14 and the seat 13 and the fixed cutter blades 16 may also be fixed or secured on the table 10 without being moved or adjusted relative to the table 10.

As shown in FIGS. 2, 4, and 9, the platform 12 includes a curved groove 18 formed therein, and preferably having a geographic center or a center of curvature located at the adjacent areas between the cutter edges 24 of the cutter blades 23 and the cutter edges 17 of the fixed cutter blades 16. A control device 19 may be disposed on the table 10 to control or to operate the cutting machine.

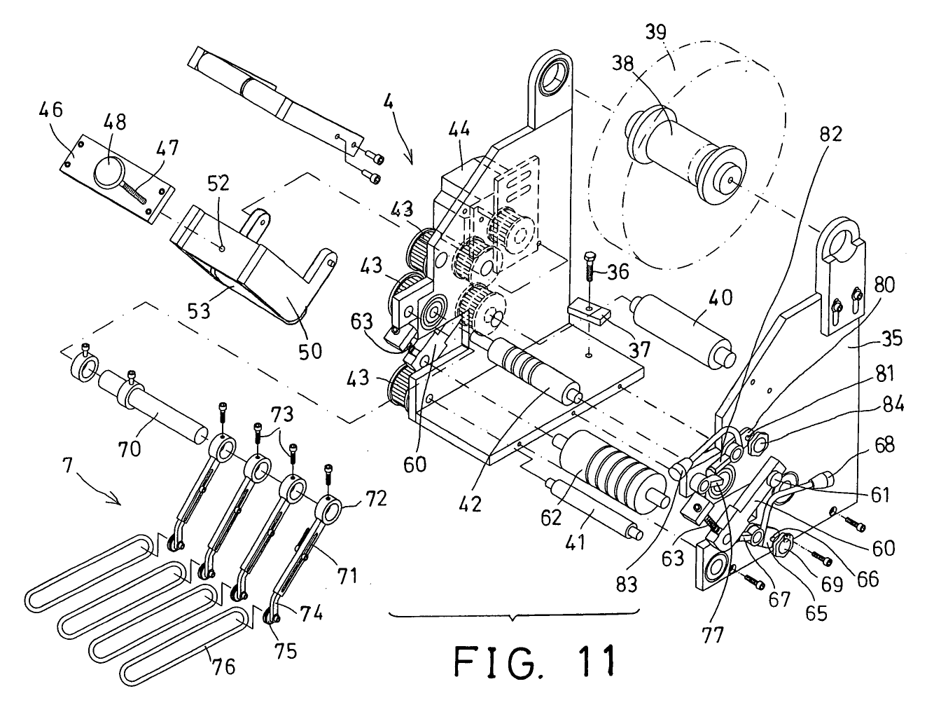

As shown in FIGS. 1-4, and 9-11, a housing 35 is rotatably attached onto the platform 12, and includes a fastener 36 engaged through the bottom of the housing 35, and slidably engaged in the curved groove 18 of the platform 12, to rotate or adjust the housing 35 relative to the platform 12 to selected angular positions, and to secure the housing 35 to the platform 12 with one or more brackets 37.

The housing 35 includes a spindle 38 rotatably disposed or supported thereon, to rotatably support a reel of the paper sheet 39 thereon. The paper sheet 39 is to be gradually fed or sent toward or through the cutter blades 16, 23, for being cut between or by the cutter edges 24 of the cutter blades 23 and the cutter edges 17 of the fixed cutter blades 16.

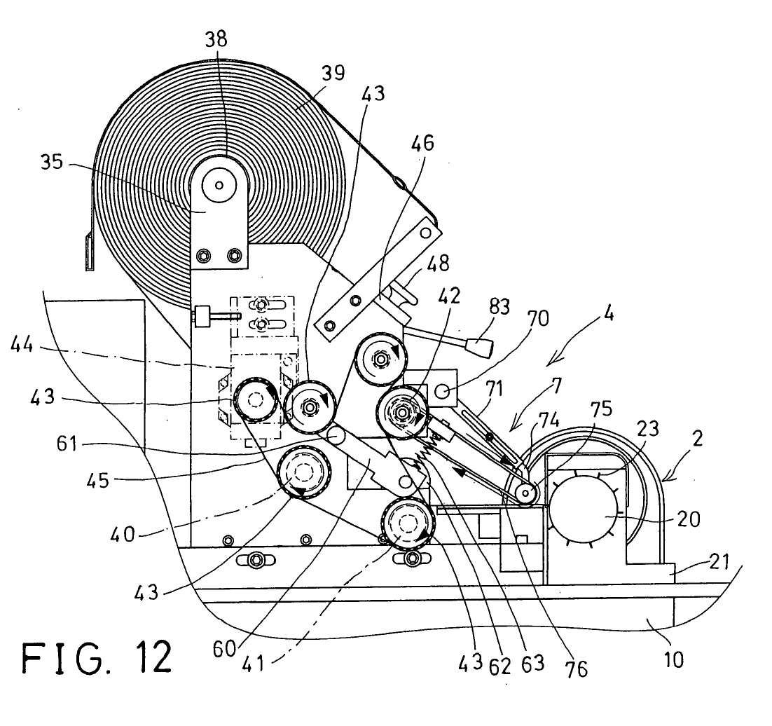

Referring next to FIG. 12 and again to FIGS. 1-4, and 9-11, a paper feeding device 4 is attached to the housing 35, and includes one or more, such as three rollers 40, 41, 42 rotatably attached or secured to the housing 35, and each of the rollers 40-42 includes a rotary member 43 attached thereto and coupled to a motor 44 via a sprocket-and-chain coupling device (not shown), or a gearing device (not shown), or a belt coupling device 45 (FIG. 12), for allowing the rollers 40-42 to be rotated or driven by the motor 44.

In operation, the paper sheet 39 may be engaged around or over the rollers 40-42, and may thus be fed or sent toward the cutter blades 16, 23 when the rollers 40-42 are rotated or driven by the motor 44. For example, the paper sheet 39 may be fed or sent toward the cutter blades 16, 23 step by step, for allowing the paper sheet 39 to be cut into the paper cut chips 9 by the cutter blades 16, 23.

As shown in FIGS. 10-13, a bar 46 may be secured onto the housing 35 with such as fasteners, and a bolt or fastener or threaded member 47 may be rotatably attached to the bar 46, and a knob 48 attached or secured to an outer end of the threaded member 47, to rotate the threaded member 47 relative to the bar 46 and the housing 35.

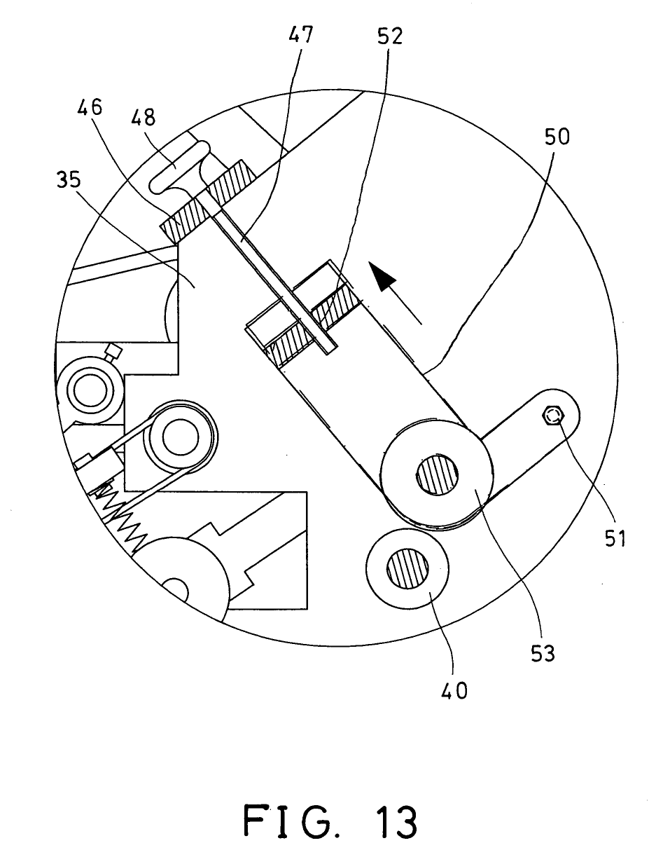

A frame or a casing 50 includes one end pivotally or rotatably secured to the housing 35 with a pivot pin 51, and includes a screw hole 52 formed in the other end thereof, for threading with the threaded member 47, and includes a wheel 53 attached to the middle portion thereof, and located beside or close or above or adjacent to the roller 40 (FIG. 13).

The wheel 53 may be adjusted toward and away from the roller 40 by rotating the threaded member 47 relative to the bar 46 or the housing 35 or the frame or casing 50, in order to adjust the gap between the wheel 53 and the roller 40, and thus for allowing the paper sheet 39 of various thicknesses to be suitably engaged with or effectively sent or fed toward the cutter blades 16, 23 by the roller 40.

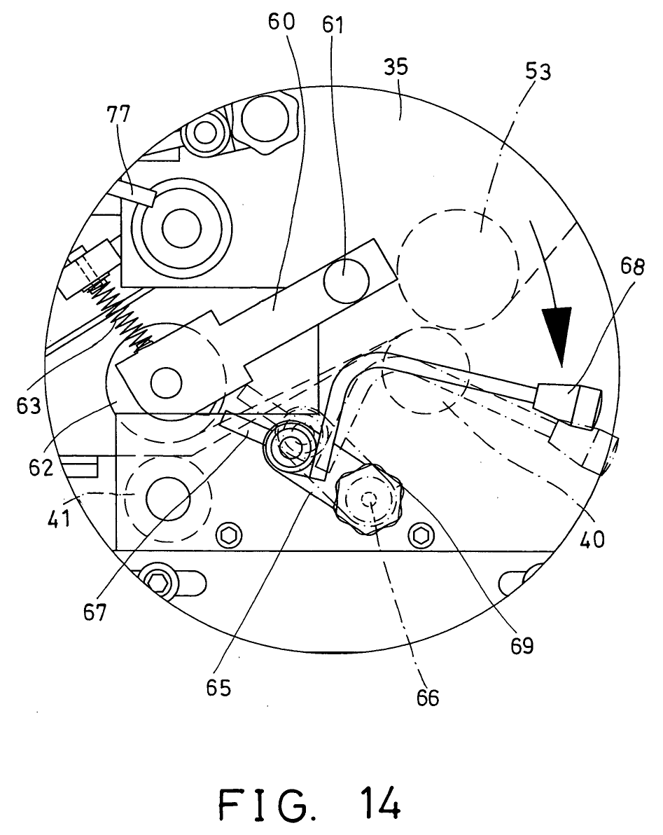

Referring next to FIG. 14 and again to FIGS. 1-4, and 9-12, one or more, such as two beams 60 include one end pivotally or rotatably attached to the housing 35 with pivot axles 61. Another wheel 62 is rotatably attached to the other ends of the beams 60. A spring 63 is attached to the housing 35 and engaged with the beams 60, to bias the beams 60 toward the roller 41, and thus for allowing the paper sheet 39 of various thicknesses to be suitably engaged with or effectively sent or fed toward the cutter blades 16, 23 by the roller 41.

As shown in FIG. 14, a lever 65 has one end pivotally or rotatably attached to the housing 35 with a fastener 66, and has an actuator 67 formed or provided on the other end thereof, for engaging with one of the beams 60, and for moving or adjusting the wheel 62 relative to the roller 41, and thus for adjusting the relative position between the wheel 62 and the roller 41, and thus for effectively feeding the paper sheet 39 of various thicknesses toward the cutter blades 16, 23.

A hand grip 68 may be attached or coupled to the lever 65, to rotate or adjust the lever 65 relative to the housing 35 about the pivot shaft 66, and thus to adjust the wheel 62 relative to the roller 41. After the wheel 62 has been adjusted relative to the roller 41 to the required position, a knob 69 of the fastener 66 may rotate the fastener 66 relative to the housing 35, to secure the lever 65 to the housing 35, and thus to retain the wheel 62 relative to the roller 41 at the required or predetermined position.

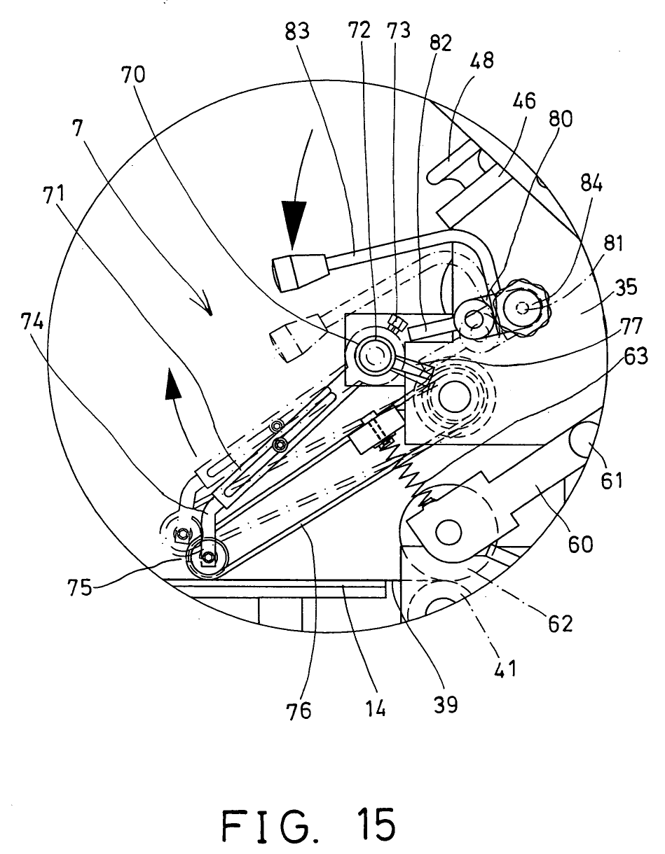

Referring next to FIG. 15 and again to FIGS. 1-4, and 9-12, a pressing device 7 is further provided for engaging with and for further feeding the paper sheet 39 toward the cutter blades 16, 23, and includes a shaft 70 rotatably attached to the housing 35. One or more arms 71 each has a sleeve 72 attached or provided on one end thereof for rotatably engaging onto the shaft 70, and fixable to the shaft 70 with fasteners 73.

Each of the arms 71 includes an extension 74 attached thereto and extendible or retractable relative to the respective arm 71, and a wheel 75 attached to the extension 74. Each of the wheels 75 are coupled to the roller 42 with a belt 76, for allowing the wheels 75 to be rotated relative to the extensions 74 of the arms 71 by the roller 42. The wheels 75 may also be engaged with the paper sheet 39, for further feeding the paper sheet 39 toward the cutter blades 16, 23. The shaft 70 includes a projection 77 extended therefrom or attached thereto and disposed out of the housing 35.

Another lever 80 has one end pivotally or rotatably attached to the housing 35 with a fastener 81, and has an actuator 82 formed or provided on the other end thereof, for engaging with the projection 77 of the shaft 70, and for rotating or adjusting the arms 71 and thus the wheels 75 relative to the paper sheet 39 and the plate 14, and thus for adjusting the relative position between the wheels 75 and the paper sheet 39, and thus for effectively feeding the paper sheet 39 of various thicknesses toward the cutter blades 16, 23.

A hand grip 83 may be attached or coupled to the lever 80, to rotate or adjust the lever 80 relative to the housing 35 about the pivot shaft 81, and thus to adjust the wheels 75 relative to the paper sheet 39. After the wheels 75 have been adjusted relative to the paper sheet 39 to the required position, a knob 84 of the fastener 81 may rotate the fastener 81 relative to the housing 35, to secure the lever 80 to the housing 35, and thus to retain the wheels 75 relative to the paper sheet 39 at the required or predetermined position.

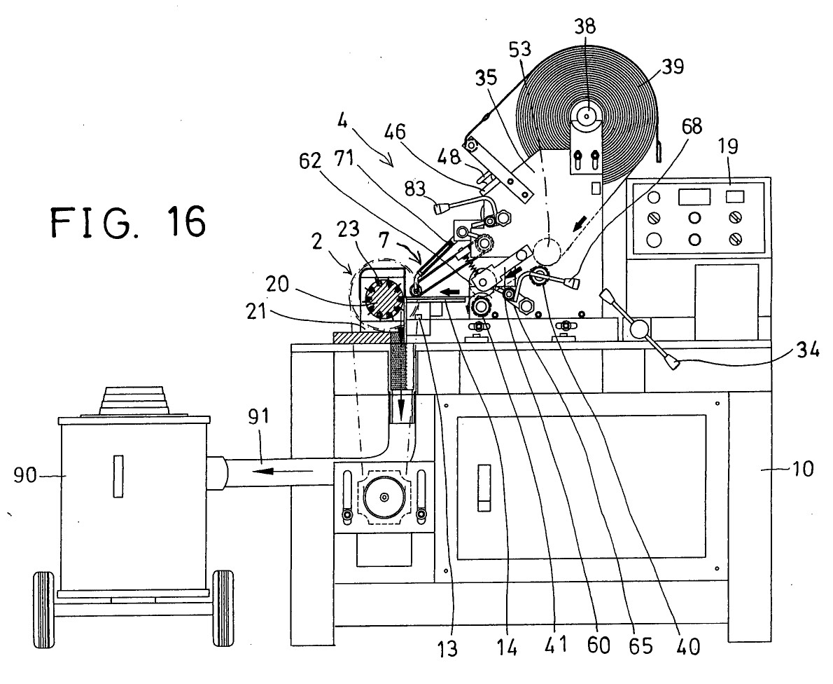

In operation, as shown in FIG. 16, the paper sheet 39 may be unwound from the spindle 38, and engaged over the rollers 40, 41, and pressed against the rollers 40, 41 with the wheels 53, 62 respectively. In addition, the wheels 75 may be engaged onto or engaged with the paper sheet 39, and may be rotated by the roller 42 via the belts 76, for further smoothly feeding the paper sheet 39 toward the cutter blades 16, 23.

The platform 12 may be moved or adjusted relative to the tracks 11 of the table 10, in order to move or adjust the cutter edges 17 of the fixed cutter blades 16 relative to the cutter edges 24 of the cutter blades 23, best shown in FIG. 8, in order to determine the areas or widths or lengths or shapes of the paper cut chips 9 to be formed.

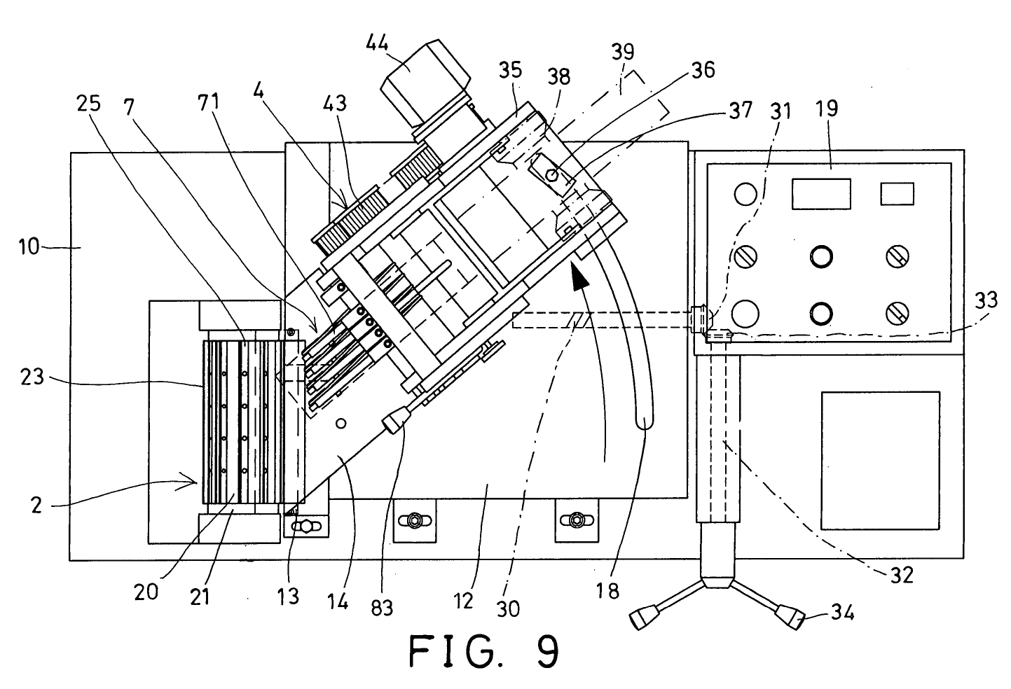

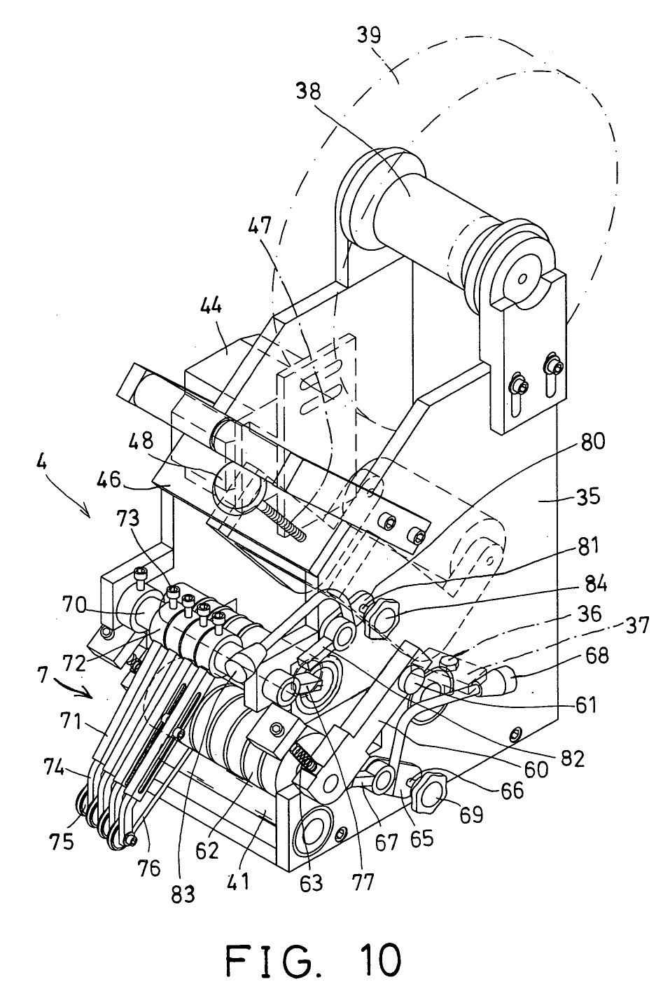

In addition, the housing 35 and thus the paper sheet 39 and the paper feeding device 4 may be rotated or adjusted relative to the plate 14 or the platform 12, best shown in FIGS. 4 and 9, in order to feed the paper sheet 39 toward the cutter blades 16, 23 in suitable or predetermined angular position, such that the paper cut chips 9 of various kinds of shapes, as shown in FIGS. 17-19, may be easily and quickly cut or formed or manufactured with the cutting machine.

After the paper cut chips 9 are formed, a vacuum device 90 may further be provided and includes a hose 91 coupled to a collecting port 93 of the table 10, in order to draw and to collect the paper cut chips 9.

Accordingly, the cutting machine in accordance with the present invention may be used for automatically or easily and quickly cutting paper sheets or gold foils or the like into smaller cut chips, and/or for automatically collecting the cut chips, for allowing the smaller cut chips to be quickly manufactured or formed by the cutting machine.

Although this invention has been described with a certain degree of particularity, it is to be understood that the present disclosure has been made by way of example only and that numerous changes in the detailed construction and the combination and arrangement of parts may be resorted to without departing from the spirit and scope of the invention as hereinafter claimed.

1. A cutting machine comprising:
a table,
a housing supported on said table,
a reel of paper sheet disposed on said housing,
a fixed cutter blade disposed on said table, and including a cutter edge,
a drum rotatably supported on said table,
at least one cutter blade attached to said drum and rotated in concert with said drum, and including a cutter edge disposed adjacent to and movable relative to said cutter edge of said fixed cutter blade, and
means for feeding said paper sheet toward said fixed cutter blade and said at least one cutter blade, for being cut by said cutter edge of said fixed cutter blade and said at least one cutter blade into cut chips.

2. The cutting machine as claimed in claim 1 further comprising a platform slidably attached to said table and movable relative to said table, said fixed cutter blade being disposed on said platform and movable relative to said at least one cutter blade.

3. The cutting machine as claimed in claim 2 further comprising means for adjusting said fixed cutter blade relative to said at least one cutter blade.

4. The cutting machine as claimed in claim 3, wherein said adjusting means includes a bolt rotatably supported on said table and threaded to said platform and having a bevel gear provided thereon, a rod rotatably supported on said table and having a bevel gear attached thereto and engaged with said bevel gear of said bolt, to rotate said bolt to adjust said platform relative to said table, and to adjust a relative position between said cutter edges of said fixed cutter blade and said at least one cutter blade.

5. The cutting machine as claimed in claim 2 further comprising a housing disposed on said platform, to support said reel of paper sheet.

6. The cutting machine as claimed in claim 5, wherein said platform includes a curved groove formed therein, and a fastener is engaged through said housing and slidably engaged in said curved groove of said platform, to rotate and adjust said housing relative to said platform to selected angular positions.

7. The cutting machine as claimed in claim 1, wherein said drum includes at least one slot formed therein to receive said at least one cutter blade.

8. The cutting machine as claimed in claim 7, wherein said drum includes at least one slot formed therein to receive said at least one cutter blade, and a bar engaged into said at least one slot of said drum and secured to said drum and engaged with said at least one cutter blade, to secure said at least one cutter blade to said drum.

9. The cutting machine as claimed in claim 1, wherein said drum includes at least one second cutter blade attached to said drum and rotated in concert with said drum, and having a cutter edge disposed adjacent to and movable relative to said cutter edge of said fixed cutter blade.

10. The cutting machine as claimed in claim 1 further comprising a housing disposed on said table, and a spindle rotatably supported on said housing, to support said reel of paper sheet.

11. The cutting machine as claimed in claim 10, wherein said paper sheet feeding means includes a roller rotatably attached to said housing, to engage with said paper sheet and to feed said paper sheet toward said fixed cutter blade and said at least one cutter blade.

12. The cutting machine as claimed in claim 11, wherein said housing includes a wheel rotatably received therein and located adjacent to said roller, to retain said paper sheet between said roller and said wheel.

13. The cutting machine as claimed in claim 12, wherein said housing includes a casing pivotally secured therein to support said wheel.

14. The cutting machine as claimed in claim 13, wherein said housing includes a threaded member rotatably attached thereto, and threaded with said casing, to adjust said casing and said wheel toward and away from said roller.

15. The cutting machine as claimed in claim 11, wherein said housing includes a wheel pivotally attached thereto with at least one beam, and said wheel is located adjacent to said roller, to retain said paper sheet between said roller and said wheel.

16. The cutting machine as claimed in claim 15 further comprising means for biasing said at least one beam and said wheel toward said roller.

17. The cutting machine as claimed in claim 15 further comprising a lever pivotally attached to said housing with a fastener and including an actuator provided thereon for engaging with said at least one beam, and for moving and adjusting said wheel relative to said roller.

18. The cutting machine as claimed in claim 1 further comprising a housing disposed on said table, said paper sheet feeding means including a roller and a shaft rotatably attached to said housing, at least one arm attached to said shaft and having a wheel attached thereto for engaging with said paper sheet, and a belt coupling said wheel to said roller.

19. The cutting machine as claimed in claim 18, wherein said at least one arm includes an extension attached thereto, and extendible or retractable relative to said at least one arm, and said wheel is attached to said extension of said at least one arm.
